(19) United States
(12) Patent Application Publication
(10) Pub. No.: US 2016/0078674 A1
(43) Pub. Date: Mar. 17, 2016

(54) THREE-DIMENSIONAL SCENE MODEL GENERATING METHOD

(71) Applicant: TSINGHUA UNIVERSITY, Beijing (CN)

(72) Inventors: Kun Xu, Beijing (CN); Kang CHEN, Beijing (CN); Weilun SUN, Beijing (CN); Shimin HU, Beijing (CN)

(21) Appl. No.: 14/786,818

(22) PCT Filed: Dec. 25, 2013
(86) PCT No.: PCT/CN2013/090463

§ 371 Date: Oct. 23, 2015

(30) Foreign Application Priority Data
Apr. 23, 2013 (CN) 201310144170.2

(51) Int. Cl. G06T 17/00; G06T 15/00

(52) U.S. Cl. CPC G06T 17/00; G06T 15/005; G06T 2200/04; G06T 2200/08

(57) ABSTRACT

three-dimensional scene model generating method, comprising: analyzing and extracting object structure groups of a scene and the semantic relationship of objects from a scene model library; counting and fitting the relative position of the objects in each object structure group, and calculating a Gaussian distribution function; : retrieving each object in the sketch in the model library; : determining a model corresponding to the sketch; calculating the initial position of the corresponding object according to the sketch; finding out a local optimal position according to the initial position calculated and the Gaussian distribution function in combination with a gradient descent method, and placing each model according to the position to obtain a final scene model.

### CROSS-REFERENCE TO RELATED APPLICATIONS

This application is the National Stage of International Application No. PCT/CN2013/090463, filed Dec. 25, 2013, which claims the benefit of Chinese Patent Application No. 201310144170.2, filed Apr. 23, 2013, the disclosures of which are incorporated herein by reference in their entireties.

### TECHNICAL FIELD

The present invention relates to the field of three-dimensional technology, especially relates to three-dimensional scene model generating method, and in particular to a three-dimensional scene model generating method based on sketches.

### BACKGROUND

With the increase of the number of three-dimensional models on the Internet (e.g., model libraries such as GOOGLE 3D WAREHOUSE or the like) and the development of the growing mature technology of retrieving three-dimensional models via two-dimensional sketches, the technology of reasonably utilizing a single model to combine a necessary scene becomes possible. A large number of studies show that randomly drawn two-dimensional sketches can be both used for retrieving models and providing the position information of objects in scenes to help to optimize the placement of scene models, which greatly reduces the modeling workload. The technical background of the present invention is mainly derived from the above-mentioned two aspects.

The most mainstream method of retrieving models via sketches is the paper entitled Eitz et al., “How do humans sketch objects” “, ACM Transactions on Graphics, July 2012, 31(4), and contents described in the quotation thereof. These methods are dedicated to improving the model retrieval effect of a single sketch, often with little regard for the semantic relationship between the models in the scenes. Moreover, due to the limitations of the two-dimensional sketches, great ambiguity exists in the expression of contents and spatial relationships, and these methods are only highly dependent on users to resolve these ambiguities.

In recent years, some progress has been made on researches of automatic optimization of three-dimensional model positions, and the main target of these researches is to place the models on reasonable positions to form beautiful scenes. The most direct application is how to automatically determine the placement positions of all kinds of furniture to make a room become beautiful and comfortable. These researches mainly include: Merrell et al, “Interactive furniture layout using interior design guidelines”, ACM Transactions on Graphics, July 2011, 30(4), Yu et al., “Make it home: automatic optimization of furniture arrangement”, ACM Transactions on Graphics, July 2011, 30(4), and Fisher et al “Context-based search for 3D models”, ACM Transactions on Graphics, December 2010, 29(6).

At present, the major mainstream methods of generating three-dimensional models based on sketches, such as Shin et al., “Magic canvas: interactive design of a 3-d scene prototype from freehand sketches”, Graphics Interface Conference, Montreal, Canada, May 28-30, 2007, Lee et al., “Sketch-Based Search and Composition of 3D Models”, 2008, In Proc. Eurographics Workshop on Sketch-Based Interfaces and Modeling, and Xie et al., “Sketch-to-Design: Context-based Part Assembly”, Computer Graphics Forum, 2013, 32(8) are all based on the design mode of a single object: retrieving the three-dimensional models from the two-dimensional sketches at first, and then placing the models. Since the semantic relationships of objects are not considered, the effects of these methods require that the required model must be accurately retrieved from each sketch. To do this, these systems require a large amount of user intervention and require a lot of professional knowledge as well.

### SUMMARY

### (1) Technical Problem to be Solved

The technical problem to be solved in the present invention is to provide a three-dimensional scene model generating method, which is used for overcoming the defects in the prior art and automatically generating an accurate and beautiful three-dimensional scene from an input sketch on the premise of minimal user intervention.

### (2) Technical Solutions

The present invention provides a three-dimensional scene model generating method, including:

S1: pre-processing stage:

S11: analyzing and extracting a plurality of object structure groups of a scene from a scene model library, wherein each object structure group defines the semantic relationship of the objects in the scene;

S12: counting and fitting the relative position of the objects in each object structure group, and calculating a Gaussian distribution function;

S2: generating stage:

S21: inputting a scene expressed by a sketch, and retrieving each object in the sketch in the model library;

S22: determining an object model corresponding to the sketch in combination with the retrieval result in S21 and the semantic relationship in S1;

S23: calculating the initial position of the corresponding object model according to the sketch;

S24: finding out a local optimal position according to the initial position calculated in S23 and the Gaussian distribution function in S12 in combination with a gradient descent method, and placing each object model in S22 according to the position to obtain a final scene model, wherein the local optimal position is the reasonable placement position of the model.

Wherein, in S11, a common object structure group with a highest association degree and defined by the Apriori algorithm is extracted from the scene by means of data mining association rules.

Wherein S23 specifically includes: directly projecting objects placed on the ground onto the ground in the scene according to a certain proportion, matching supporting surfaces of objects placed on other objects from the input sketch by means of an image method, interpolating on the supporting surfaces, and calculating the positions of the objects relative to the supporting objects.

Wherein, in S11, the plurality of object structure groups include at least one object structure group.

### (3) Beneficial Effects

By adopting the method provided by the present invention, the semantic information of the scene is fully utilized to improve the accuracy of the model retrieval method based on sketches, and the ambiguity in the input sketch is automatically solved on the premise of minimal user intervention, so that users without professional knowledge can create scene models comparable with those created by the professionals by means of the system in the present invention. In addition, the present invention has good scalability, and the proposed conception of structure groups can also provide a thought for solving problems in other fields.

### BRIEF DESCRIPTION OF THE DRAWINGS

FIG. 1 is a flowchart of steps of a three-dimensional scene model generating method in the present invention;

FIG. 2 is a processing flowchart of example 1 of a three-dimensional scene model generating method based on sketches in the present invention; and

FIG. 3 is a schematic diagram of a part of results of a three-dimensional scene model generating method based on sketches and a result made on the same model library.

### DETAILED DESCRIPTION OF THE PREFERRED EMBODIMENTS

A further detailed description of specific implementation manners of the present invention will be given below in combination with accompanying drawings and embodiments. The following embodiments are used for illustrating the present invention, rather than limiting the scope of the present invention.

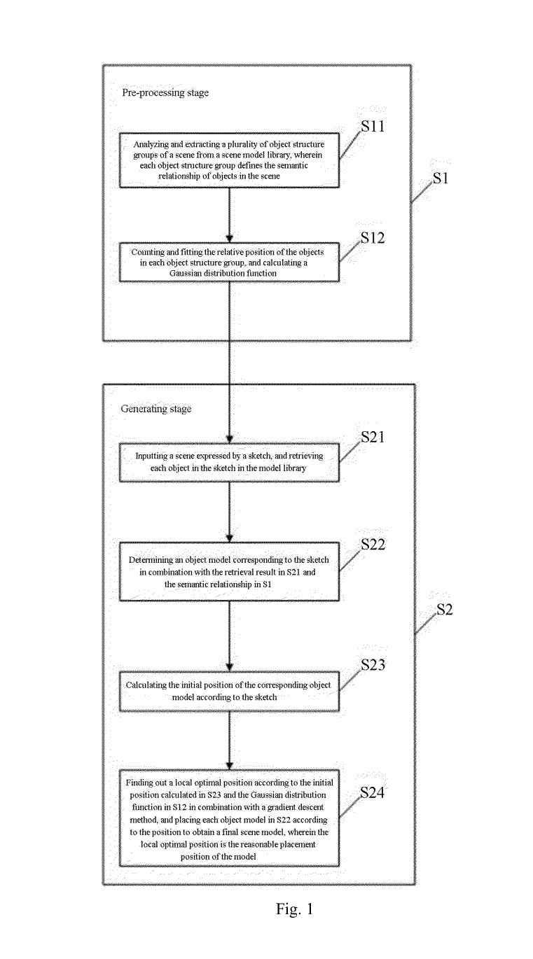

As shown in FIG. 1, the present invention provides a three-dimensional scene model generating method, including:

S1: pre-processing stage:

S11: analyzing and extracting a plurality of object structure groups of a scene from a scene model library, wherein each object structure group defines the semantic relationship of objects in the scene;

S12: counting and fitting the relative position of the objects in each object structure group, and calculating a Gaussian distribution function;

S2: generating stage:

S21: inputting a scene expressed by a sketch, and retrieving each object in the sketch in the model library;

S22: determining an object model corresponding to the sketch in combination with the retrieval result in S21 and the semantic relationship in S1;

S23: calculating the initial position of the corresponding object model according to the sketch;

S24: finding out a local optimal position according to the initial position calculated in S23 and the Gaussian distribution function in S12 in combination with a gradient descent method, and placing each object model in S22 according to the position to obtain a final scene model, wherein the local optimal position is the reasonable placement position of the model.

Wherein, in S11, a common object structure group with a highest association degree and defined by the Apriori algorithm is extracted from the scene by means of data mining association rules; (the Apriori algorithm is a frequent itemset algorithm used for mining the association rules, and the core idea thereof is to mine a frequent itemset by two stages of candidate set generation and downward scenario closure detection. Moreover, the algorithm has been widely used in various fields, such as business, network security and the like.)

Wherein, S23 specifically includes: directly projecting objects placed on the ground onto the ground in the scene according to a certain proportion, matching supporting surfaces of objects placed on other objects from the input sketch by means of an image method, interpolating on the supporting surfaces, and calculating the positions of the objects relative to the supporting objects.

Wherein, in S11, the plurality of object structure groups include at least one object structure group.

### Embodiment 1

FIG. 2 is a processing flowchart of example 1 of a three-dimensional scene model generating method based on sketches in the present invention, and as shown in FIG. 2:

(1) Processing Stage:

Common structure groups are analyzed and extracted from a scene database at the stage. For example, FIG. 1 shows two structure groups “TV—cabinet” and “bedside table—bed—bedside table”. In the first structure group, the relationship between “TV” and “cabinet” is that the “TV” is placed on the “cabinet” and it can be seen from a fitted Gaussian function that the center of the “TV” is distributed relatively to the center of the “cabinet”. In the second structure group, the “bed” and the two “bedside tables” are all placed on the ground, and the two “bedside tables” are generally placed at approximately symmetrical positions at both sides of the “bed”.

(2) Operation Stage:

The operation state is composed of the following four parts:

a. A scene sketch is input, it can be seen that different objects in the scene sketch are expressed by different colors and the scene sketch is well “divided”.

b. The sketch of each object in the input scene sketch is matched with outline images generated from different visual angles of all the models in a model library by using an image matching method, and all the models in the model library are sequenced in a descending order according to similarity. It can be seen that each expected category of model cannot be guaranteed to be ranked at the first due to the limitation of a single sketch retrieval model.

c. Former 100 candidate models are extracted from each object sketch for combination and optimization, besides considering the sketch matching score, if containing the structure group extracted at the pre-processing stage, the score of a pre-defined structure group will be added in each combination. The combination with the highest score is extracted in a greedy manner, in order to obtain a final model corresponding to each object in the scene sketch. The position of each model is estimated from the sketch, and the models are placed on respective estimated positions.

A potential function relevant to object translation and rotation is defined, and the potential function simultaneously requires that the relative position relationship of the objects in the structure group contained in the scene obeys the preset Gaussian function as much as possible and requires that the position and direction of each object cannot be too far away from the initial estimated position. A locally optimal solution is found out by a gradient descent method, and the models are placed on finally determined positions.

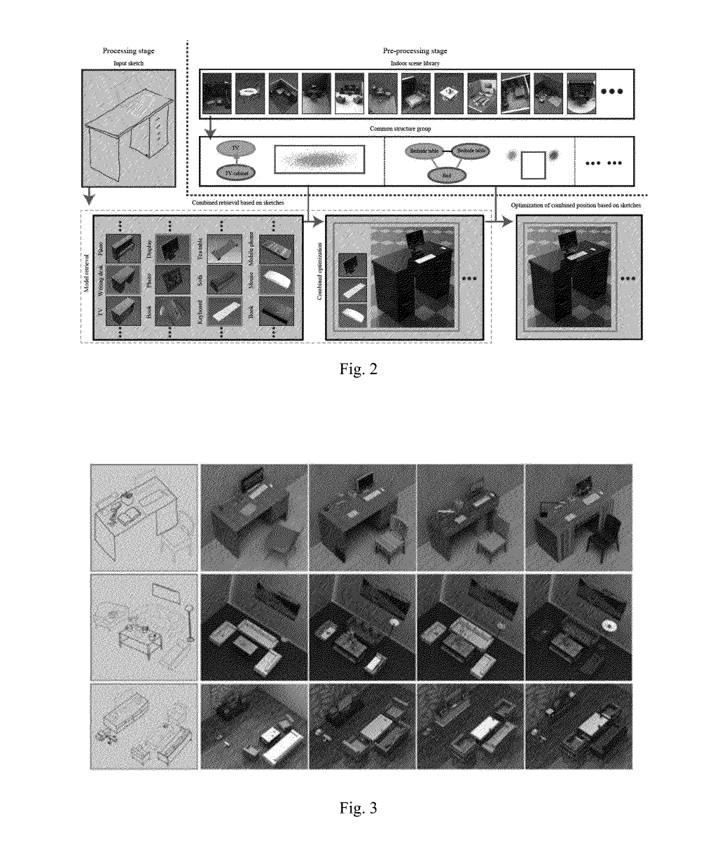

As shown in FIG. 3, the first column is some input sketches, and the second column is scenes made by invited professional art designers on the same model library according to the sketches. The third, fourth and fifth columns are results automatically generated by the system in the present invention. It can be seen that, the results generated in the present invention basically have the same visual effects as the results made by the art designers.

The above-mentioned embodiments are merely used for illustrating the present invention, rather than limiting the present invention. Those of ordinary skill in the art can make various variations and deformations without departing from the spirit and scope of the present invention. Accordingly, all the equivalent technical solutions belong to the scope of the present invention, and the protection scope of the present invention should be defined by the claims.

1. A three-dimensional scene model generating method, comprising:
S1: pre-processing stage:
S11: analyzing and extracting a plurality of object structure groups of a scene from a scene model library, wherein each object structure group defines the semantic relationship of objects in the scene;
S12: counting and fitting the relative position of the objects in each object structure group, and calculating a Gaussian distribution function;
S2: generating stage:
S21: inputting a scene expressed by a sketch, and retrieving each object in the sketch in the model library;
S22: determining an object model corresponding to the sketch in combination with the retrieval result in S21 and the semantic relationship in S1;
S23: calculating the initial position of the corresponding object model according to the sketch;
S24: finding out a local optimal position according to the initial position calculated in S23 and the Gaussian distribution function in S12 in combination with a gradient descent method, and placing each object model in S22 according to the position to obtain a final scene model, wherein the local optimal position is the reasonable placement position of the model.

2. The method of claim 1, wherein in S11, a common object structure group with a highest association degree and defined by the Apriori algorithm is extracted from the scene by means of data mining association rules.

3. The method of claim 1, wherein S23 specifically comprises: directly projecting objects placed on the ground onto the ground in the scene according to a certain proportion, matching supporting surfaces of objects placed on other objects from the input sketch by means of an image method, interpolating on the supporting surfaces, and calculating the positions of the objects relative to the supporting objects.

4. The method of claim 1, wherein in S11, the plurality of object structure groups comprise at least one object structure group.
